(19) United States
(12) Patent Application Publication
(10) Pub. No.: US 2025/0010937 A1
(43) Pub. Date: Jan. 9, 2025

(54) EASILY-ASSEMBLED SWING-TYPE TRICYCLE

(71) Applicant: Ningbo Xinglong Juchuang Electrical Technology Co., Ltd., Ningbo (CN)

(72) Inventor: Jianhua Fang, Ningbo (CN)

(73) Assignee: Ningbo Xinglong Juchuang Electrical Technology Co., Ltd., Ningbo, ZH (CN)

(21) Appl. No.: 18/708,492

(22) PCT Filed: Mar. 8, 2022
(86) PCT No.: PCT/CN2022/079729

§ 371 Date: May 8, 2024

(30) Foreign Application Priority Data
Nov. 8, 2021 (CN) 202111314307.5

(51) Int. Cl. B62K 5/06; B62J 43/13; B62J 45/411; B62K 5/027; B62L 1/02; B62M 17/00

(52) U.S. Cl. CPC B62K 5/06; B62J 43/13; B62J 45/411; B62K 5/027; B62L 1/02; B62M 17/00

(57) ABSTRACT

An easily-assembled swing-type tricycle, comprises a frame assembly, a wheel frame (4) arranged on the frame assembly, a transmission chamber arranged in the frame assembly and a transmission mechanism arranged in the transmission chamber; The frame assembly comprises a front frame (1), a swinging mechanism (3) and a gear box (2), the front frame (1) is connected to the gear box (2) through the swinging mechanism (3), and the gear box (2) is connected to the wheel frame (4). The transmission mechanism is arranged in the transmission chamber in the frame assembly, so that the transmission mechanism does not need to be mounted outside the frame, and the product is more compact in structure, the transmission mechanism can be pre-assembled in the transmission chamber before the product is packed and transported, reducing the assembly procedure by the consumer.

### TECHNICAL FIELD OF THE INVENTION

The present invention relates to the field of tricycles, and in particular to an easily-assembled swing-type tricycle.

### BACKGROUND OF THE INVENTION

As commonly used light vehicles in the daily life, pedal tricycles are as light as bicycles and can carry more articles. With the progress of technology, in order to save the rider's physical strength, electric boosting tricycles have emerged, in which a signal of crank shaft rotation is detected mainly relying on the torque sensor at the crank shaft, and then the controller controls the motor to supply power to the driving wheel of the tricycle, thus saving the rider's physical strength. Such boosting tricycles are essentially different from the electric motorcycle type tricycles, for example, the way of controlling the rotation of motor is different, no throttle is arranged on the handlebar in the electric boosting tricycle, the rider drives the crank shaft by pedaling, and the crank shaft triggers the torque sensor, so that the controller controls the motor to drive the driving wheel of the tricycle, and it is more reliable in safety.

The main reason why the tricycle is easy to turn over when turning is that the center of gravity of the tricycle will shift to between the front wheel and the outer rear wheel when tricycle is turning a corner, so that the tricycle is very easy to tilt and turn over under the action of the centrifugal force. Therefore, tricycles with swinging mechanisms adopting unilateral transmission for the rear wheels appear on the market. The main structure of such a tricycle comprises a front frame, a rear frame and a swinging mechanism arranged between the front frame and the rear frame, by the swinging mechanism, the front frame can swing in a certain range relative to the rear frame in horizontal immovability and can automatically return to its original position. When such a tricycle turns a corner, the front frame can radially swing at a certain angle relative to the rear frame, so that the center of gravity of the tricycle is moved toward the inner side of the curve and the tricycle is more stable and reliable when turning the corner. Since the front frame needs to swing, if using the conventional transmission structure, the transmission chain will be twisted in a FIG. 8 shape, and it is difficult to ride normally. The existing tricycles with swinging mechanisms are designed as a multi-section transmission agent. As shown in FIGS. 1 and 2, the tricycle includes a front frame 101 and a rear frame 102, wherein a support frame 1021 extending downward is arranged on the rear frame 102, and a swinging mechanism 111 is arranged on the support frame 1021; the front frame 101 is connected to the swinging mechanism 111, a first transmission sprocket 103 is arranged on one side of the rear portion of the front frame 101, and a second transmission sprocket 104 is arranged on the other side of the front portion of the rear frame 102; the first transmission sprocket 103 and the second transmission sprocket 104 are arranged opposite to each other and connected through a multi-stage universal joint 105, the first transmission sprocket 103 is in transmission connection to a driving sprocket 107 on a crank shaft of the front frame 101 through a first chain 106; and, the second transmission sprocket 104 is in transmission connection to a rear sprocket 109 on one rear wheel 110 through a second chain 108. When the front frame 101 tilts through the swinging mechanism 111, the first chain 106, the first transmission sprocket 103 and the driving sprocket 107 also tilt accordingly, and the multi-stage universal joint 105 changes in shape, thereby ensuring that the second transmission sprocket 104 is not subject to the stress caused by the tilting of the front frame 101, and maintaining the normal transmission of power. However, in the above technical solution, the power needs to pass through the first chain 106, the first transmission sprocket 103, the multi-stage universal joint 105, the second transmission sprocket 104, the second chain 108 and the rear sprocket 109 to drive the rear wheels 110 to rotate, this belongs to the multi-stage transmission, the transmission agent is complicated, and has large number of transmission components, moreover, since these transmission components installed on the outer side of the frame either adopt chain linkage or universal joint linkage, they need to be adjusted after the tricycle is assembled, so that it is difficult to realize pre-assemble the tricycle before being packed, which makes the assembling process of the tricycle after unpacking very complicated. Particularly, for consumers with poor hands-on ability, it will be a great challenge to assemble the transmission agent above. Moreover, the rear frame structure in the prior art leads to a large span between the topmost surface and the bottommost surface and is of an integrated structure, so a large space will be occupied during packing, the packaging volume of the product is increased as a whole, and the transportation cost of the product is higher.

### SUMMARY OF THE INVENTION

The technical problem to be solved by the present invention is to overcome the deficiencies of the prior art and provide an easily-assembled swing-type tricycle with simple structure and small packaging volume.

The easily-assembled swing-type tricycle provided by the present invention employs the following main technical scheme: The easily-assembled swing-type tricycle comprises a frame assembly, a wheel frame arranged on the frame assembly, a transmission chamber arranged in the frame assembly and a transmission mechanism arranged in the transmission chamber, wherein two rear wheels are symmetrically arranged on the wheel frame, and a front wheel is arranged on the frame assembly; the frame assembly comprises a front frame, a swinging mechanism and a gear box, the front frame is connected to the gear box through the swinging mechanism, the gear box is connected to the wheel frame, the transmission mechanism comprises a driving shaft arranged on the gear box, and, the driving shaft is in linkage cooperation with at least one of the two rear wheels.

The easily-assembled swing-type tricycle provided by the present invention also employs the following auxiliary technical schemes:

The wheel frame comprises a framework, two wheel installation members symmetrically arranged on the framework and wheel transmission shafts arranged on the wheel installation members, the rear wheels are arranged on the wheel transmission shafts, and, the driving shaft is connected to at least one of the wheel transmission shafts.

Brake pad mechanisms are arranged on the wheel installation members, brake drums or brake discs are arranged on the rear wheels and the brake pad mechanisms cooperate with the brake drums or brake discs.

The driving shaft is connected to the wheel transmission shaft through a universal shaft assembly.

The universal shaft assembly comprises a spline shaft, and a first universal joint and a second universal joint that are arranged at two ends of the spline shaft, the first universal joint is connected to the driving shaft, and the second universal joint is connected to the wheel transmission shaft; a first spline sleeve is arranged on the first universal joint, and a second spline sleeve is arranged on the second universal joint, and, two ends of the spline shaft are in plug-in cooperation with the first spline sleeve and the second spline sleeve in a sliding manner, respectively.

A bearing plate is arranged on the framework, and the gear box is connected to the bearing plate through bolts.

The wheel installation members are detachably mounted on the framework through bolts.

The swinging mechanism comprises a first swinging member, a second swinging member, a connecting shaft and an elastic block, the elastic block is clamped between the first swinging member and the second swinging member, the first swinging member and the second swinging member are connected in a rotatable manner through the connecting shaft, a first connecting portion is provided on the first swinging member, and a second connecting portion is provided on the second swinging member, and, the first connecting portion is connected to the front frame, and the second connecting portion is connected to the gear box.

The transmission chamber comprises a shaft moving chamber and a shaft moving passage which are arranged in the front frame, a transmission via hole formed in a middle portion of the swinging mechanism, and a gear moving chamber arranged in the gear box; and, the shaft moving chamber, the shaft moving chamber, the transmission via hole and the gear moving chamber are communicated successively.

The transmission mechanism comprises a first torque output assembly arranged in the shaft moving chamber, a second torque output assembly arranged in the gear moving chamber, and a transmission shaft which penetrates through the shaft moving passage and the transmission via hole, and, the first torque output assembly is in linkage with the second torque output assembly through the transmission shaft.

The first torque output assembly comprises a middle shaft arranged in the shaft moving chamber, and cranks are provided at two ends of the middle shaft; and, the second torque output assembly comprises the driving shaft, and the length of the driving shaft is less than or equal to that of the middle shaft.

The easily-assembled swing-type tricycle further comprises a storage battery arranged on the frame assembly or the wheel frame, a boosting motor arranged on the front wheel and a torque sensor arranged in the transmission mechanism, and both the storage battery and the torque sensor are connected to the boosting motor.

Compared with the prior art, the easily-assembled swing-type tricycle provided by the present invention has the following advantages: In the present application, the transmission mechanism is arranged in the transmission chamber in the frame assembly, so that the transmission mechanism does not need to be set up outside the frame, the product is more compact in structure and clean and neat in appearance, and the transmission mechanism will not be interfered, squeezed or hooked by the outside; With this structure, the transmission mechanism can be pre-assembled in the transmission chamber before the product is packed and transported, reducing the assembly procedure by the consumers; After purchasing this product, the consumers only need to mount the wheel frame 4 on the frame assembly, then mount the wheels and connect the driving shaft to the rear wheels so as to complete assembling, so that the assembling process of the product is greatly simplified, and it is not difficult for persons with poor hands-on ability to assemble; In addition, the gear box on the frame assembly is connected to the wheel frame, compared with the prior art, the wheel frame does not need to provide with a support frame extending downward to connect to the swinging mechanism, so that the structure of the wheel frame 4 is smoother, the space occupation when packing is reduced, and the transportation cost is reduced.

### BRIEF DESCRIPTION OF THE DRAWINGS

FIG. 1 is a structure diagram of a tricycle with a swingable frame in the prior art;

FIG. 2 is a bottom view of the tricycle with a swingable frame in the prior art;

FIG. 3 is a structure diagram of an easily-assembled swing-type tricycle according to the present invention;

FIG. 4 is a structure diagram of the frame assembly and the wheel frame after being assembled together according to the present invention;

FIG. 5 is a structure diagram of the wheel frame according to the present invention;

FIG. 6 is a structure diagram of the brake drum according to the present invention;

FIG. 7 is a structure diagram of the swinging mechanism according to the present invention;

FIG. 8 is a structure diagram of the swinging mechanism after the connecting cover is removed according to the present invention;

FIG. 9 is a structure diagram of the connecting cover of the swinging mechanism according to the present invention;

FIG. 10 is a structure diagram of the first swinging member of the swinging mechanism according to the present invention;

FIG. 11 is a structure diagram of the frame assembly according to the present invention;

FIG. 12 is an enlarged view of A in FIG. 11;

FIG. 13 is a side view of the frame assembly according to the present invention;

FIG. 14 is an enlarged view of B in FIG. 13;

FIG. 15 is a partially sectional view of the frame assembly according to the present invention;

FIG. 16 is a top view of the frame assembly according to the present invention;

FIG. 17 is an enlarged view of C in FIG. 16;

FIG. 18 is a first exploded view of the structure of the clutch assembly according to the present invention;

FIG. 19 is a second exploded view of the structure of the clutch assembly according to the present invention; and

FIG. 20 is a structure diagram of the easily-assembled swing-type tricycle after being equipped with the storage battery according to the present invention.

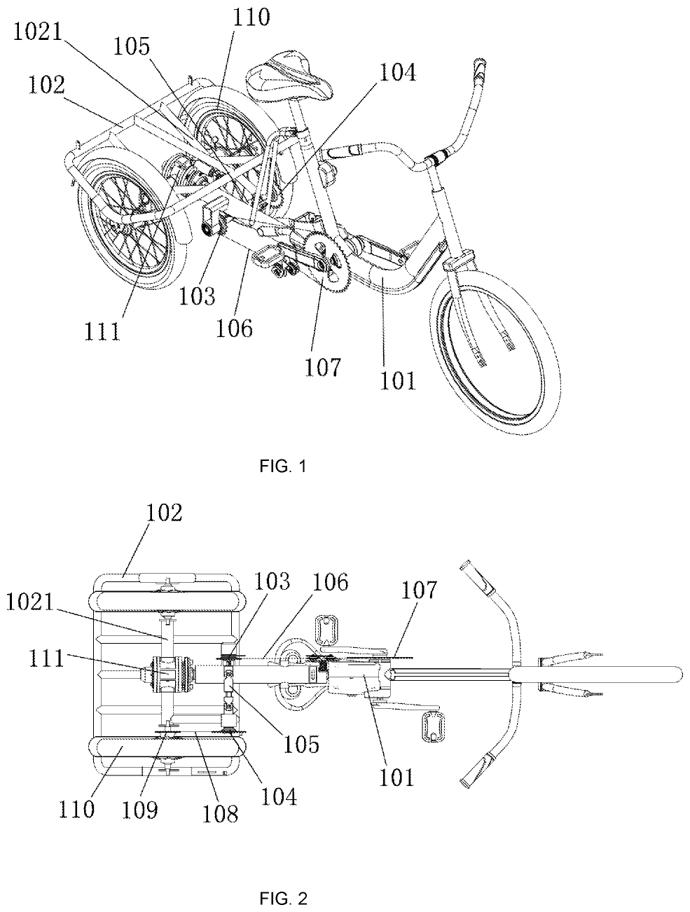

### DETAILED DESCRIPTION OF THE INVENTION

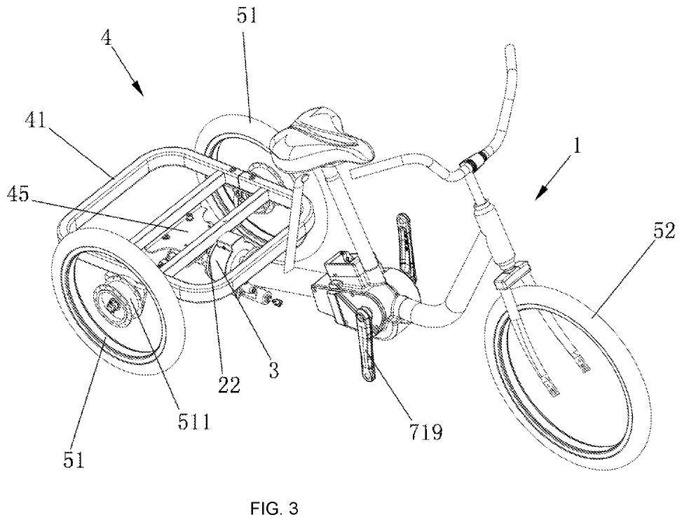

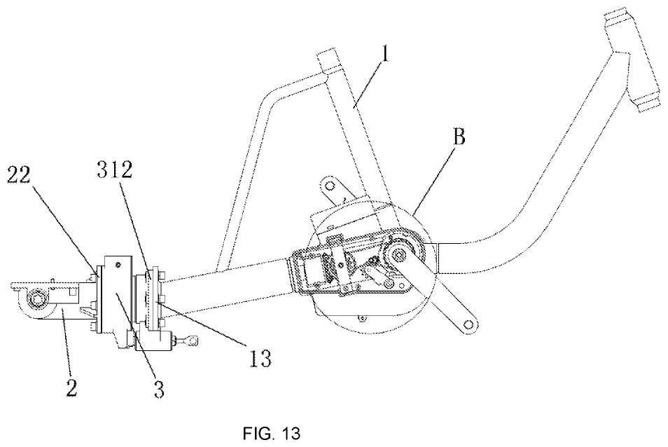

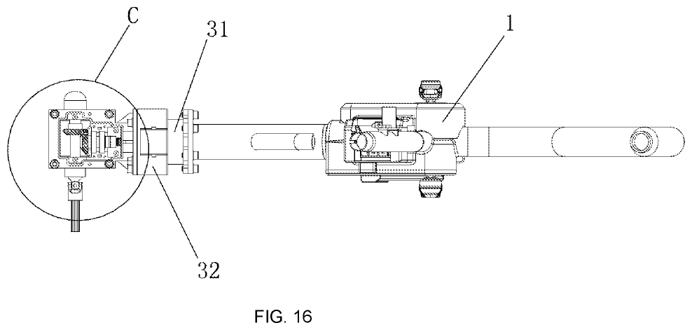

With reference to FIGS. 3-5 and 11-16, an embodiment of the easily-assembled swing-type tricycle provided by the present invention comprises a frame assembly, a wheel frame 4 arranged on the frame assembly, a transmission chamber arranged in the frame assembly and a transmission mechanism arranged in the transmission chamber; Two rear wheels 51 (the rear wheels in the figures are structure diagrams) are symmetrically arranged on the wheel frame 4, and a front wheel 52 (the front wheel in the figures is a structure diagram) is arranged on the frame assembly; The frame assembly comprises a front frame 1, a swinging mechanism 3 and a gear box 2. The front frame 1 is connected to the gear box 2 through the swinging mechanism 3, and the gear box 2 is connected to the wheel frame 4, the transmission mechanism comprises a driving shaft 721 arranged on the gear box 2, the driving shaft 721 is in linkage cooperation with at least one of the two rear wheels 51. The easily-assembled swing-type tricycle further comprises a seat, pedals arranged on the cranks and other components, which are all the existing technologies on the tricycle and will not be repeated here. In this structure, the transmission mechanism is arranged in the transmission chamber in the frame assembly, so that the transmission mechanism does not need to be set up outside the frame, the product is more compact in structure and clean and neat in appearance, and the transmission mechanism will not be interfered, squeezed or hooked by the outside; With this structure, the transmission mechanism can be pre-assembled in the transmission chamber before the product is packed and transported, reducing the assembly procedure by the consumers; After purchasing this product, the consumers only need to mount the wheel frame 4 on the frame assembly, then mount the wheels and connect the driving shaft 721 to the rear wheels 51 so as to complete assembling, so that the assembling process of the product is greatly simplified, and it is not difficult for persons with poor hands-on ability to assemble; In addition, the gear box 2 on the frame assembly is connected to the wheel frame 4, compared with the prior art, the wheel frame 4 does not need to provide with a support frame extending downward to connect to the swinging mechanism 3, so that the structure of the wheel frame 4 is smoother, the space occupation when packing is reduced, and the transportation cost is reduced.

With reference to FIGS. 3-5, according to the above embodiment of the present invention, the wheel frame 4 comprises a framework 41, two wheel installation members 42 symmetrically arranged on the framework 41 and wheel transmission shafts 43 arranged on the wheel installation members 42; the rear wheels 51 are arranged on the wheel transmission shafts 43; and, the driving shaft 721 is connected to at least one of the wheel transmission shafts 43. The wheel frame 4 is simple in structure, and the real wheels 51 are linked to rotate through the wheel transmission shafts 43 on the wheel frame 4, compared with the prior art, sprockets are arranged on the hubs of the rear wheels 51 and the hubs are driven to rotate along the shaft through chains, the process of assembling sprockets and chains on the hubs is removed, and the process of mounting the rear wheels 51 is greatly simplified.

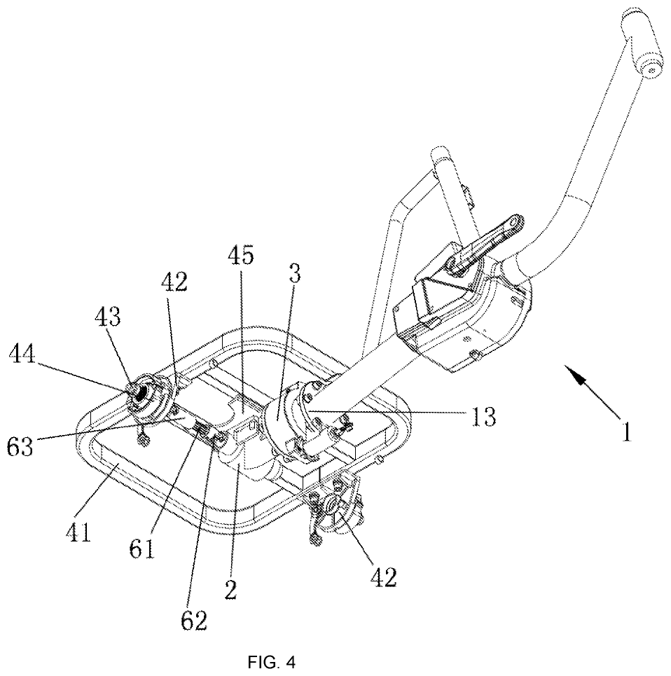

With reference to FIGS. 4-6, according to the above embodiment of the present invention, brake pad mechanisms 44 are arranged on the wheel installation members 42, brake drums 511 or brake discs are arranged on the rear wheels 51, and the brake pad mechanisms 44 cooperates with the brake drums 511 or brake discs. No matter the brake pad mechanisms 44 cooperated with the brake drums 511 or the brake pad mechanisms 44 cooperated with the brake discs, both are mature technologies in the prior art and will not be repeated here. In this embodiment, it is preferred to provide brake drums 511 on the rear wheels 51. In the present invention, by using the brake pad mechanisms 44 above, the process of assembling the rear wheels 51 is further simplified, the assembling efficiency of the rear wheels 51 is improved, and the safety and reliability of the product are improved.

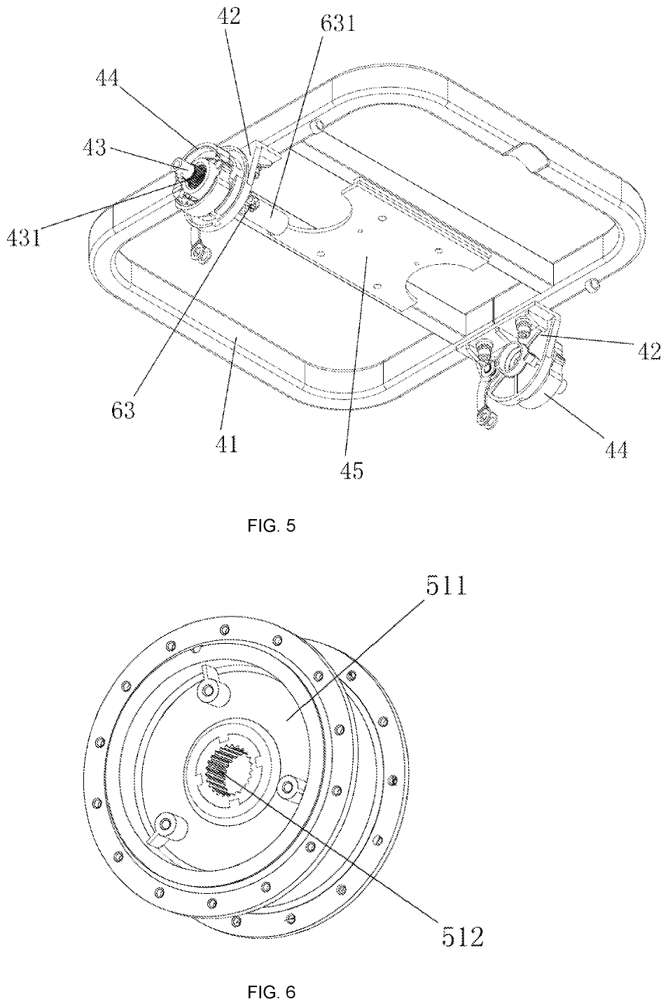

With reference to FIGS. 5 and 6, according to the above embodiment of the present invention, spline holes 512 are formed in the middle portions of the brake drums 511, shaft splines 431 are arranged on the wheel transmission shafts 43, and the spline holes 512 are sleeved on the wheel transmission shafts 43 and cooperate with the shaft splines 431. This structure facilitates the assembling of the rear wheels 51.

With reference to FIGS. 4 and 5, according to the above embodiment of the present invention, the driving shaft 721 is connected to the wheel transmission shaft 43 through a universal shaft assembly. This structure can effectively overcome the assembling problem caused by the precision error during the production of the wheel frame 4, realize good matching between the frame assembly and the wheel frame 4, and greatly improve the yield of the product.

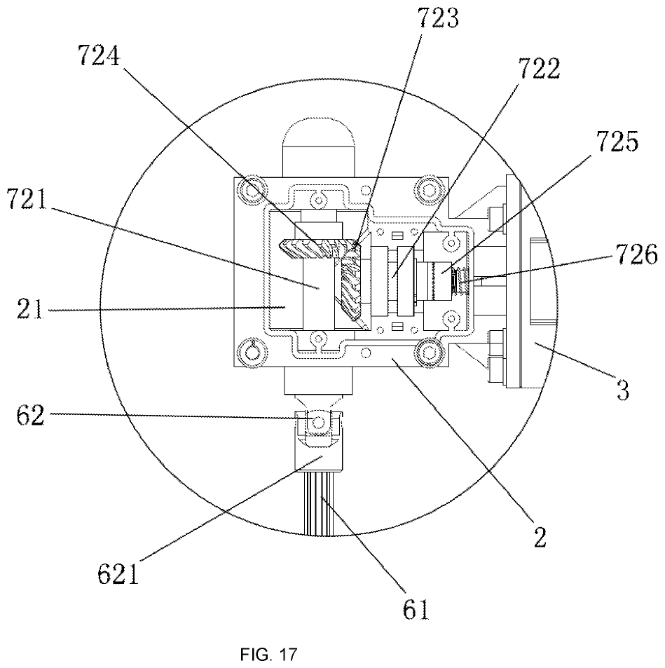

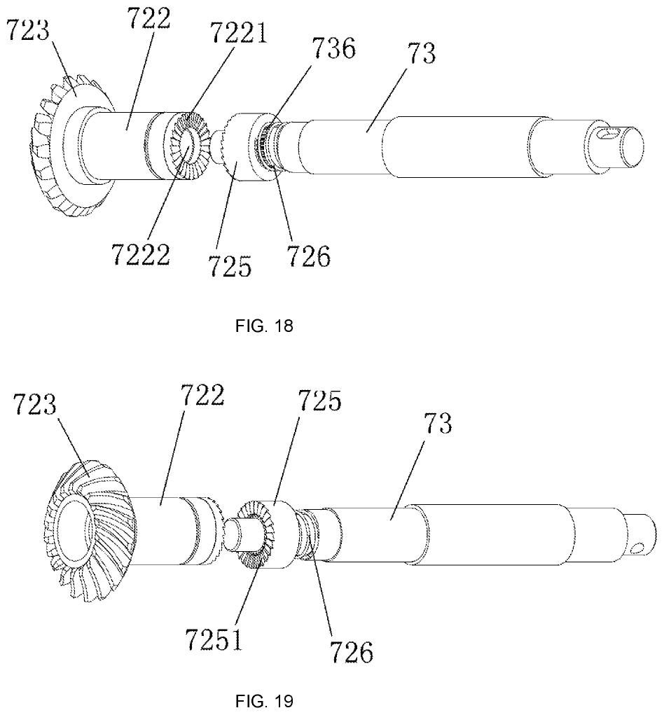

With reference to FIGS. 4, 5, 11 and 17, according to the above embodiment of the present invention, the universal shaft assembly comprises a spline shaft 61, and a first universal joint 62 and a second universal joint 63 that are arranged at two ends of the spline shaft 61, the first universal joint 62 is connected to the driving shaft 721, and the second universal joint 63 is connected to the wheel transmission shaft 43; a first spline sleeve 621 is arranged on the first universal joint 62, and a second spline sleeve 631 is arranged on the second universal joint 63, and, two ends of the spline shaft 61 are in plug-in cooperation with the first spline sleeve 621 and the second spline sleeve 631 in a sliding manner, respectively. The universal structure assembly has simple structure, few components and easy assembly; When packing, the first universal joint 61 is connected to the transmission shaft 73, and the second universal joint 63 is connected to the wheel transmission shaft 43. After the consumer unpacks the tricycle, the linkage cooperation between the driving shaft 721 and the wheel transmission shaft 43 can be realized by inserting two ends of the spline shaft 61 into the first spline sleeve 621 and the second spline shaft 631, respectively, so that the assembling efficiency and reliability of the product are further improved.

With reference to FIGS. 3-5, according to the above embodiment of the present invention, a bearing plate 45 is arranged on the framework 41, and the gear box 2 is connected to the bearing plate 45 through a bolt. The bearing plate 45 can be used as a connector between the framework 41 and the gear box 2, and can also be a cover plate of the gear box 2. After being mounted, the bearing plate 45 covers the gear box 2, so that the sealing performance of the gear box 2 is ensured and it is convenient to assemble the frame assembly and the wheel frame 4.

With reference to FIGS. 3-5, according to the above embodiment of the present invention, the wheel installation members 42 are detachably mounted on the framework 41 through bolts. With this structure, the wheel installation members 42 can be quickly assembled or disassembled, so that the wheel frame 4 can be further disassembled, it is more advantageous to reduce the volume of packing, and the transportation cost of the product is saved.

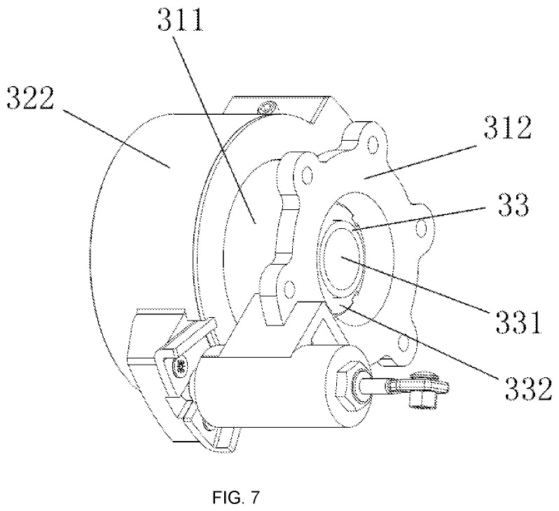

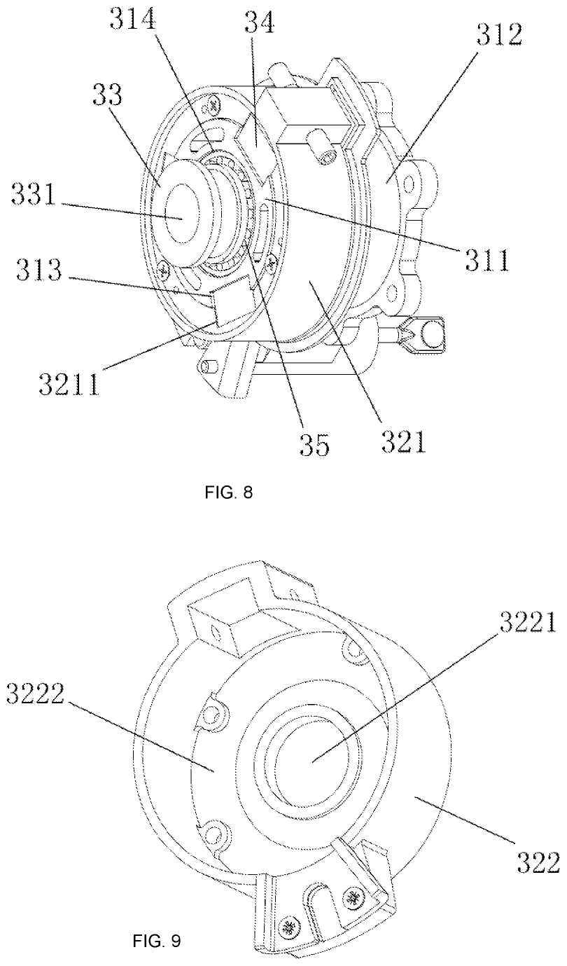

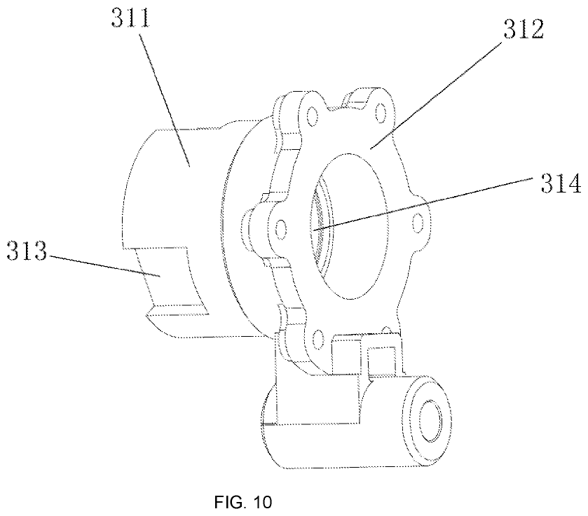

With reference to FIGS. 4, 7, 8, 9, 10, 13 and 16, according to the above embodiment of the present invention, the swinging mechanism 3 comprises a first swinging member 31, a second swinging member 32, a connecting shaft 33 and an elastic block 34, the elastic block 34 is clamped between the first swinging member 31 and the second swinging member 32, the first swinging member 31 and the second swinging member 32 are connected in a rotatable manner through the connecting shaft 33, a first connecting portion 312 is provided on the first swinging member 31, and a second connecting portion 3222 is provided on the second swinging member 32, and, the first connecting portion 312 is connected to the front frame 1, and the second connecting portion 3222 is connected to the gear box 2. A third connecting portion 13 is arranged on the front frame 1, and a fourth connecting portion 22 is arranged on the gear box 2; The first connecting portion 312 is connected to the third connecting portion 13, and the second connecting portion 3222 is connected to the fourth connecting portion 22. The first connecting portion 312, the second connecting portion 3222, the third connecting portion 13 and the fourth connecting portion 22 are all flange structures. A transmission via hole 331 is formed in the middle portion of the connecting shaft 33.

With reference to FIGS. 4, 7, 8, 9, 10, 13 and 16, according to the above embodiment of the present invention, the swinging member 31 comprises a swinging shaft 311 and the first connecting portion 312 arranged at one end of the swinging shaft 311, the second swinging member 32 comprises a shaft sleeve 321 and a connecting cover 322 sleeved on the shaft sleeve 321, the second connecting portion 3222 is arranged on the connecting cover 322; Outer clamping slots 313 are formed on the outer wall of the swinging shaft 311, and inner clamping slots 3211 are formed on the inner wall of the shaft sleeve 321; The other end of the swinging shaft 311 is inserted into the shaft sleeve 321, the outer clamping slots 313 are opposite to the inner clamping slots 3211, one end of the elastic block 34 is inserted into the inner clamping slot 3211, while the other end of the elastic block 34 is inserted into the outer clamping slot 313; A first insertion hole 314 is formed in the middle portion of the swinging shaft 311, and a second insertion hole 3221 is formed on the connecting cover 322, the connecting shaft 33 passes through the second insertion hole 3221 and the first insertion hole 314 to connect the first swinging member 31 to the second swinging member 32 in a rotatable manner; The transmission via hole 331 is formed in the middle portion of the connecting shaft 33. The elastic block 34 may be a rubber elastic block. There are a plurality of outer clamping slots 313 which are uniformly formed on the outer wall of the swinging shaft 311, and there are a plurality of inner clamping slots 3211 which are uniformly formed on the inner wall of the shaft sleeve 321. A locking nut 332 is further provided on the connecting shaft 33, and the first swinging member 31 and the second swinging member 32 are connected in a rotatable manner by cooperating with the locking nut 322. A bearing 35 is arranged between the outer wall of the connecting shaft 33 and the inner wall of the first insertion hole 314. When the swinging mechanism is in a stationary state, the elastic block 34 is not deformed, when the first swinging member 31 is twisted relative to the second swinging member 32, the middle portion of the elastic block 34 is squeezed and deformed. With the automatic restoration of the elastic block 34, the first swinging member 31 is also restored to the initial state. Since the first swinging member 31 and the second swinging member 32 twist along the connecting shaft 33, the axis center line of the connecting shaft 33 is the axis center line of the swinging mechanism 3. The first connecting portion 312 of the swinging mechanism 3 is connected to the front frame 1 of the tricycle, and the second connecting portion 3222 is connected to the gear box 2 of the tricycle, particularly, the transmission via hole 331 is provided for allowing the transmission shaft 73 to pass therethrough, so that the two rotating components, the swinging mechanism 3 and the transmission shaft 73, are organically combined, thus providing favorable conditions for the production of the swingable shaft-driven tricycle, and facilitating the simplification of the transmission mechanism of this tricycle, moreover, the swinging mechanism has simple and compact structure, few components, convenient assembling and low production cost.

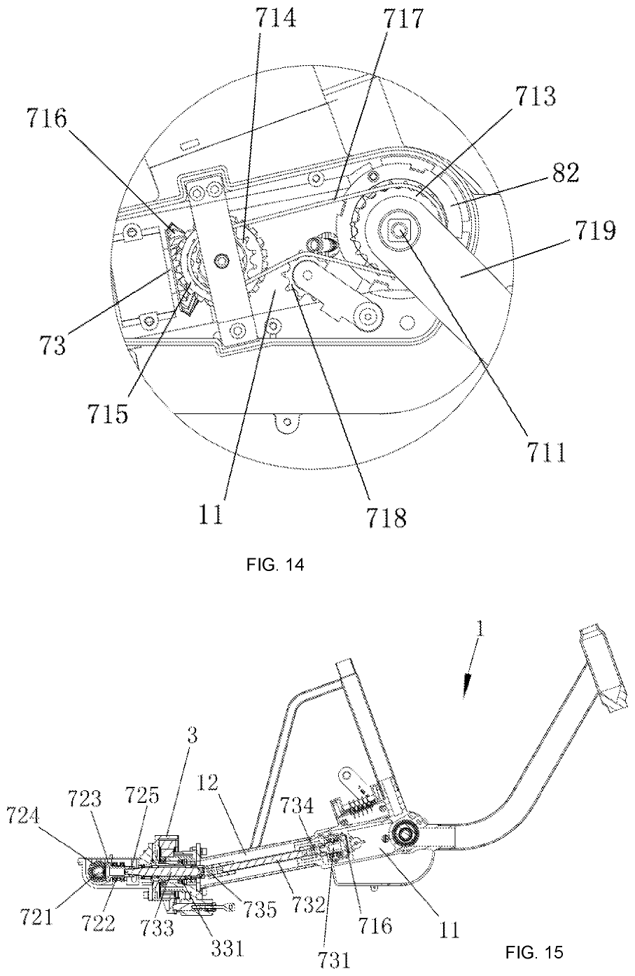

With reference to FIGS. 14-17, according to the above embodiment of the present invention, the transmission chamber comprises a shaft moving chamber 11 and a shaft moving passage 12 which are arranged in the front frame 1, a transmission via hole 331 formed in a middle portion of the swinging mechanism 3, and a gear moving chamber 21 arranged on the gear box 2; and, the shaft moving chamber 11, the shaft moving passage 12, the transmission via hole 331 and the gear moving chamber 21 are communicated successively. The transmission chamber has an ingenuous structural design, so the internal space of the frame is effectively utilized, and, by using the segmented structure, it is convenient to assemble the components of the transmission mechanism.

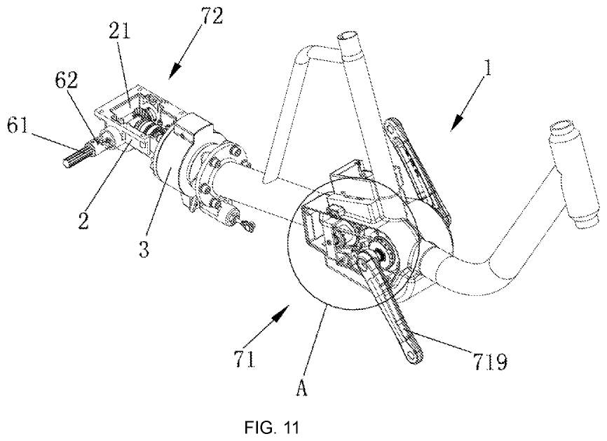

With reference to FIGS. 11-15, according to the above embodiment of the present invention, the transmission mechanism comprises a first torque output assembly 71 arranged in the shaft moving chamber 11, a second torque output assembly 72 arranged in the gear moving chamber 21, and a transmission shaft 73 which penetrates through the shaft moving passage 12 and the transmission via hole 331, and, the first torque output assembly 71 is in linkage with the second torque output assembly 72 through the transmission shaft 73. The first torque output assembly 71 comprises a middle shaft 711 and a rear shaft 712 which are arranged in the shaft moving chamber 11 in a rotatable manner, a front sprocket 713 arranged on the middle shaft 711, a rear sprocket 714 and a first bevel gear 715 arranged on the rear shaft 712, the front sprocket 713 is in linkage cooperation with the rear sprocket 714 through a chain 717, a second bevel gear 716 is arranged on the transmission shaft 73, and, the first bevel gear 715 is meshed with the second bevel gear 716. Cranks 719 are provided at two ends of the middle shaft 711, the middle shaft 711 and the rear shaft 712 are arranged in parallel, and the transmission shaft 73 is perpendicular to the rear shaft 712. The first torque output assembly 71 further comprises a tighten sprocket 718 in compression cooperation with the chain 717. With the arrangement of the tighten sprocket 718, the loose chain 717 can be compressed tightly, thereby ensuring the adaptability of a chain 717 to a variety of sprockets of different sizes, by using the tighten sprocket for elastic tight compression, firstly, the chain 717 can be prevented from falling off; secondly, when the rear sprocket 714 or the front sprocket 713 changes in diameter, the original chain 717 can still be used without adjusting the length of the chain 717. This first torque output assembly 71 is simple in structure and flexible to assemble, and is particularly suitable for tricycles with rear wheels 51 having different diameters. When the driven wheels changes in diameter, the speed ratio can be adjusted only by replacing a matched rear sprocket 714, without adjusting the whole set of first torque output assembly 71, with this structure, for automobile enterprises that produce multiple different types of vehicles, the types of components are reduced, it is helpful for standardization of assembly production lines, the production efficiency is improved, and the research and development cost for components is reduced.

With reference to FIGS. 15 and 19, according to the above embodiment of the present invention, the second torque output assembly 72 comprises the driving shaft 721 arranged in the gear moving chamber 21, the transmission shaft 73 is in linkage with the driving shaft 721 through a second gear pair, a clutch assembly is arranged between the transmission shaft 73 and the second gear pair or between the driving shaft 721 and the second gear pair, the driving shaft 721 is in linkage cooperation with at least one of the two rear wheels 51. The second gear pair comprises a third bevel gear 723 and a fourth bevel gear 724 which are meshed with each other, the fourth bevel gear 724 is arranged on the driving shaft 721, and, the transmission shaft 73 is in linkage with the third bevel gear 723 through the clutch assembly. The clutch assembly comprises a torque input shaft 722 arranged on the third bevel gear 723, a first end face ratchet 7221 arranged on the torque input shaft 722, an internal spline sleeve 725 clamped on the transmission shaft 73 in a sliding manner, and an elastic member 726 for pushing the internal spline sleeve 725 to abut against the first end face racket 7221; One end of the torque input shaft 722 is connected to the third bevel gear 723, while the other end of the torque input shaft 722 is provided with the first end face ratchet 7221, an external spline 736 is provided on the outer wall of the transmission shaft 73. The internal spline sleeve 725 is in sliding clamping cooperation with the external spline 736, a second end face racket 7251 is arranged at the end of the internal spline sleeve 725 opposite to the first end face racket 7221, and the first end face racket 7221 cooperates with the second end face racket 7251. The elastic member 726 is a spring sleeved on the transmission shaft 73, a positioning insertion hole 7222 is formed at the end of the torque input shaft 722 opposite to the transmission shaft 73, and the end of the transmission shaft 73 is inserted into the positioning insertion hole 7222. The third bevel gear 723, the torque input shaft 722 and the first end face ratchet 7221 are of an integral structure. It is simple in structure, few components, easy to assemble and high in reliability, the arrangement of the clutch assembly ensures that the real wheels 51 can still rotate forward when the transmission shaft 73 is in stationary state, which conforms to the riding habit for the tricycle with the conventional transmission mechanism.

With reference to FIG. 15, according to the above embodiment of the present invention, the transmission shaft 73 comprises a first segmented transmission shaft 731, a second segmented transmission shaft 732 and a third segmented transmission shaft 733, the first segmented transmission shaft 731 and the second segmented transmission shaft 732 are connected via a third universal joint 734, and the second segmented transmission shaft 732 and the third segmented transmission shaft 733 are connected via a fourth universal joint 735, the first segmented transmission shaft 731 cooperates with the first torque output assembly 71, and the third segmented transmission shaft 733 cooperates with the second torque output assembly 72. In this embodiment, by using the three-segmented transmission shaft 73, without affecting the design of the frame, the smoothness of the transmission process and the reliability of transmission are ensured.

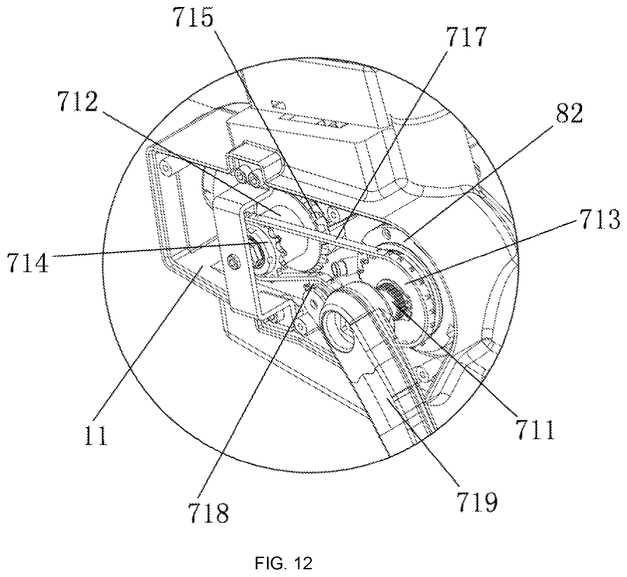

With reference to FIGS. 12 and 15, according to the above embodiment of the present invention, the length of the driving shaft 721 is less than or equal to that of the middle shaft 711. Thus, it is ensured that the front and rear widths of the frame assembly 1 are not much different, and it is advantageous for reduction of the volume of the packing box.

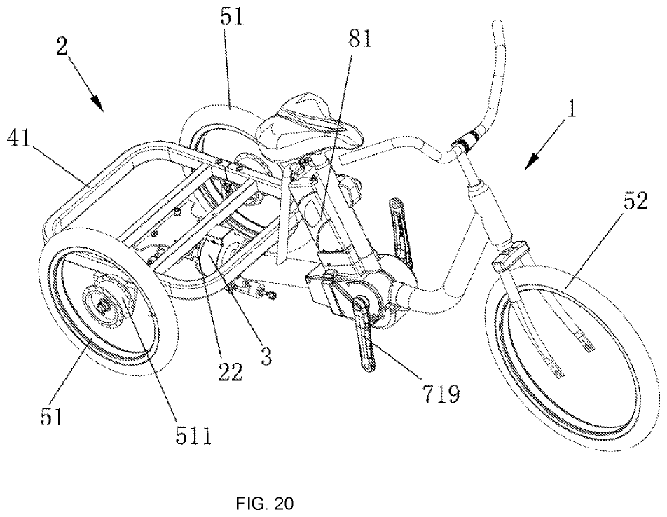

With reference to FIGS. 12 and 20, according to the above embodiment of the present invention, the easily-assembled swing-type tricycle further comprises a storage battery 81 arranged on the frame assembly or the wheel frame 4, a boosting motor (not shown in figures) arranged on the front wheel 52 and a torque sensor 82 arranged in the transmission mechanism, both the storage battery 81 and the torque sensor 82 are connected to the boosting motor. The storage battery 81 supplies power to the torque sensor 82 and the boosting motor, and the torque sensor 82 provides a driving signal to the boosting motor. In this embodiment, the storage battery 81 is arranged on the frame assembly, when the structure above is applied on an electric boosting tricycle, the reliability of the electric boosting tricycle is greatly improved, and the riding experience is greatly improved.

With reference to FIG. 11, according to the above embodiment of the present invention, a torque trigger hole is formed on the torque sensor 82, the middle shaft 711 penetrates through the torque trigger hole, and the rotation of the middle shaft 711 triggers the torque sensor 82. The torque sensor 82 with this structure can be directly triggered by the rotating shaft, that is, an extreme match to the electric boosting tricycle, so that it is helpful to simplify the overall structure of the first torque output assembly 71.

Although the embodiments of the present invention have been shown and described, it should be understood by a person of ordinary skill in the art that variations can be made to these embodiments without departing from the principle and spirit of the present invention, and the scope of the present invention shall be defined by the appended claims and equivalents thereof.

1. An easily-assembled swing-type tricycle, comprising a frame assembly, a wheel frame (4) arranged on the frame assembly, a transmission chamber arranged in the frame assembly, and a transmission mechanism arranged in the transmission chamber; wherein two rear wheels (51) are symmetrically arranged on the wheel frame (4), and a front wheel (52) is arranged on the frame assembly; the frame assembly comprises a front frame (1), a swinging mechanism (3), and a gear box (2); the front frame (1) is connected to the gear box (2) through the swinging mechanism (3); the gear box (2) is connected to the wheel frame (4); the transmission mechanism comprises a driving shaft (721) arranged on the gear box (2); and, the driving shaft (721) is in linkage cooperation with at least one of the two rear wheels (51).

2. The easily-assembled swing-type tricycle according to claim 1, wherein the wheel frame (4) comprises a framework (41), two wheel installation members (42) symmetrically arranged on the framework (41), and wheel transmission shafts (43) arranged on the wheel installation members (42); the rear wheels (51) are arranged on the wheel transmission shafts (43); and, the driving shaft (721) is connected to at least one of the wheel transmission shafts (43).

3. The easily-assembled swing-type tricycle according to claim 2, wherein brake pad mechanisms (44) are arranged on the wheel installation members (42), brake drums (511) or brake discs are arranged on the rear wheels (51), and the brake pad mechanisms (44) cooperate with the brake drums (511) or brake discs.

4. The easily-assembled swing-type tricycle according to claim 2, wherein the driving shaft (721) is connected to the wheel transmission shaft (43) through a universal shaft assembly.

5. The easily-assembled swing-type tricycle according to claim 4, wherein the universal shaft assembly comprises a spline shaft (61), and a first universal joint (62) and a second universal joint (63) that are arranged at two ends of the spline shaft (61); the first universal joint (62) is connected to the driving shaft (721), and the second universal joint (63) is connected to the wheel transmission shaft (43); a first spline sleeve (621) is arranged on the first universal joint (62), and a second spline sleeve (631) is arranged on the second universal joint (63), and, two ends of the spline shaft (61) are in plug-in cooperation with the first spline sleeve (621) and the second spline sleeve (631) in a sliding manner, respectively.

6. The easily-assembled swing-type tricycle according to claim 2, wherein a bearing plate (45) is arranged on the framework (41), and the gear box (2) is connected to the bearing plate (45) through a bolt.

7. The easily-assembled swing-type tricycle according to claim 2, wherein the wheel installation members (42) are detachably mounted on the framework (41) through bolts.

8. The easily-assembled swing-type tricycle according to claim 1, wherein the swinging mechanism (3) comprises a first swinging member (31), a second swinging member (32), a connecting shaft (33), and an elastic block (34); the elastic block (34) is clamped between the first swinging member (31) and the second swinging member (32); the first swinging member (31) and the second swinging member (32) are connected in a rotatable manner through the connecting shaft (33); a first connecting portion (312) is provided on the first swinging member (31), and a second connecting portion (3222) is provided on the second swinging member (32), and, the first connecting portion (312) is connected to the front frame (1), and the second connecting portion (3222) is connected to the gear box (2).

9. The easily-assembled swing-type tricycle according to claim 1, wherein the transmission chamber comprises a shaft moving chamber (11) and a shaft moving passage (12) which are arranged in the front frame (1), a transmission-via-hole (331) formed in a middle portion of the swinging mechanism (3), and a gear moving chamber (21) arranged in the gear box (2); and, the shaft moving chamber (11), the shaft moving passage (12), the transmission-via-hole (331) and the gear moving chamber (21) are communicated successively.

10. The easily-assembled swing-type tricycle according to claim 9, wherein the transmission mechanism comprises a first torque output assembly (71) arranged in the shaft moving chamber (11), a second torque output assembly (72) arranged in the gear moving chamber (21), and a transmission shaft (73) which penetrates through the shaft moving passage (12) and the transmission-via-hole (331); and, the first torque output assembly (71) is in linkage with the second torque output assembly (72) through the transmission shaft (73).

11. The easily-assembled swing-type tricycle according claim 1, further comprising a storage battery (81) arranged on the frame assembly or the wheel frame (4), a boosting motor arranged on the front wheel (52), and a torque sensor (82) arranged in the transmission mechanism; both the storage battery (81) and the torque sensor (82) are connected to the boosting motor.

12. The easily-assembled swing-type tricycle according to claim 2, further comprising a storage battery (81) arranged on the frame assembly or the wheel frame (4), a boosting motor arranged on the front wheel (52), and a torque sensor (82) arranged in the transmission mechanism; both the storage battery (81) and the torque sensor (82) are connected to the boosting motor.

13. The easily assembled swing-type tricycle according to claim 3, further comprising a storage battery (81) arranged on the frame assembly or the wheel frame (4), a boosting motor arranged on the front wheel (52), and a torque sensor (82) arranged in the transmission mechanism; both the storage battery (81) and the torque sensor (82) are connected to the boosting motor.

14. The easily-assembled swing-type tricycle according to claim 4, further comprising a storage battery (81) arranged on the frame assembly or the wheel frame (4), a boosting motor arranged on the front wheel (52), and a torque sensor (82) arranged in the transmission mechanism; both the storage battery (81) and the torque sensor (82) are connected to the boosting motor.

15. The easily-assembled swing-type tricycle according to claim 5, further comprising a storage battery (81) arranged on the frame assembly or the wheel frame (4), a boosting motor arranged on the front wheel (52), and a torque sensor (82) arranged in the transmission mechanism; both the storage battery (81) and the torque sensor (82) are connected to the boosting motor.

16. The easily-assembled swing-type tricycle according to claim 6, further comprising a storage battery (81) arranged on the frame assembly or the wheel frame (4), a boosting motor arranged on the front wheel (52), and a torque sensor (82) arranged in the transmission mechanism; both the storage battery (81) and the torque sensor (82) are connected to the boosting motor.

17. The easily-assembled swing-type tricycle according to claim 7, further comprising a storage battery (81) arranged on the frame assembly or the wheel frame (4), a boosting motor arranged on the front wheel (52), and a torque sensor (82) arranged in the transmission mechanism; both the storage battery (81) and the torque sensor (82) are connected to the boosting motor.

18. The easily-assembled swing-type tricycle according to claim 8, further comprising a storage battery (81) arranged on the frame assembly or the wheel frame (4), a boosting motor arranged on the front wheel (52), and a torque sensor (82) arranged in the transmission mechanism; both the storage battery (81) and the torque sensor (82) are connected to the boosting motor.

19. The easily-assembled swing-type tricycle according to claim 9, further comprising a storage battery (81) arranged on the frame assembly or the wheel frame (4), a boosting motor arranged on the front wheel (52), and a torque sensor (82) arranged in the transmission mechanism; both the storage battery (81) and the torque sensor (82) are connected to the boosting motor.

20. The easily-assembled swing-type tricycle according to claim 10, further comprising a storage battery (81) arranged on the frame assembly or the wheel frame (4), a boosting motor arranged on the front wheel (52), and a torque sensor (82) arranged in the transmission mechanism; both the storage battery (81) and the torque sensor (82) are connected to the boosting motor.
